(19) United States
(12) Patent Application Publication
(10) Pub. No.: US 2020/0259227 A1
(43) Pub. Date: Aug. 13, 2020

(54) Thermal management system for an electrical power source

(71) Applicant: L7 Drive Oy, Karjalohja (FI)

(72) Inventor: Daniel Salonen, Karjalohja (FI)

(21) Appl. No.: 16/754,767

(22) PCT Filed: Oct. 10, 2018
(86) PCT No.: PCT/FI2018/050729

§ 371 Date: Apr. 9, 2020

(30) Foreign Application Priority Data
Oct. 10, 2017 (FI) 20175889

(51) Int. Cl. H01M 10/63; H01M 10/48; H01M 10/625; H01M 10/6551; H01M 10/6552; H01M 10/6553; H01M 10/657; H01M 2/20

(52) U.S. Cl. CPC H01M 10/63; H01M 10/486; H01M 10/625; H01M 2/206; H01M 10/6552; H01M 10/6553; H01M 10/657; H01M 10/6551

(57) ABSTRACT

According to an example aspect of the present invention, there is provided an electric power source equipped with a thermal control system having an electric power source with at least two terminals for supplying electric current and at least one heat exchanger affixed to a metal surface of at least one of the at least two terminals.

### BACKGROUND

Most batteries, including lithium batteries, operate best in a relatively narrow temperature range. For example, within lithium batteries, as the battery temperature falls below 0° C. not only does the internal resistance increase, but other properties of the battery cause discharging to become difficult if not impossible. At the same time, charging the battery becomes nearly impossible without causing permanent damage to the battery. As temperature rises the ability of the battery to discharge stored energy is restored and yet a battery temperature above 40° C. has a detrimental effect on the life of the battery.

These temperature sensitivities are of special concern when lithium batteries are employed in vehicles which must work in a wide range of ambient conditions. For example, within Finland an electric vehicle could be exposed to temperatures below −40° C. and within a more arid desert region the temperature may exceed +65° C. Exposing batteries to such temperature extremes becomes of even greater concern when the battery is subjected to a high charge or discharge rate while also exposed to such extreme ambient conditions. These extreme ambient conditions can be exacerbated by the internal heat which is generated by a battery during charging and discharging due to the battery's internal resistance.

Additionally, while internal resistance varies based on battery type, it also varies due to the internal battery temperature. Depending on the temperature of the battery this internal resistance can cause as much as a 10% energy loss. In some cases, such as when there is a high current demand and the battery temperature is cold, losses may even exceed 10%. In certain cases, a further problem is experienced when the battery is so cold that the internal resistance is high enough to prevent discharging entirely. This can be caused, for example, by a battery management system (BMS) sensing a low voltage on the cell due to increased internal resistance and preventing discharge of the battery.

Given the issues with cold ambient conditions impacting battery performance it is often preferable to thermally isolate the battery. In cold conditions this allows the waste heat produced by the battery to maintain the temperature of the battery and due to the high specific thermal capacity of the battery, the battery cools quite slowly when sufficiently isolated. This allows for the battery to maintain a preferable temperature even when left unused for a period of time in a cold climate. In colder climates this thermal isolation means that the vehicle and battery do not need to be heated as often in order to maintain conditions for daily use. However, this same thermal isolation that provides better performance in colder conditions makes it much more difficult to cool the battery when needed.

Within vehicles employing lithium batteries liquid cooling is typically employed. In such cases heat is dissipated through the battery case via conduction to the liquid cooling system. In other cases convection is employed to cool the battery by supplying cool air to the battery case. Both of these systems suffer in that the transfer of heat from inside of the battery is very inefficient. As such the cooling systems need to be oversized for the amount of thermal transfer that is actually taking place. Additionally, the cooling systems presently employed can have a negative impact on the reliability of the battery, in extreme cases, liquid coolant may leak and destroy the battery.

In order to avoid damage to batteries employed in a wide range of ambient temperatures an increase the life and efficiency of batteries a new temperature management solution is needed.

Additionally, many solutions are developing which utilize a single cell battery, greatly simplified battery packs or capacitors in order to provide electric power. The benefits of such solutions are varied, but such solutions often provide a lower voltage as a source and thus must source a great deal of current in order to deliver the same energy as a higher voltage source. This higher output current necessitates larger contact terminals.

At the same time having a plurality of batteries within the same housing leads to many thermal management issues. For example, within standard battery packs having numerous cells connected in series, thermal management becomes increasingly difficult by any known means. In order to manage the thermal condition of each cell a heat exchanger would need to have access to each individual cell resulting in a complex and expensive thermal management system. Additionally, individual cell thermal management would require complex isolation for the thermal management system to avoid inadvertently shorting the cells and causing damage to the battery in addition to a rise of fire. Finally, differences in temperature of the individual cells would result in poor battery performance and thus necessitate a thermal system that can somehow insure even heat distribution, further complicating any management system.

### SUMMARY OF THE INVENTION

As discussed above many batteries employ large terminals. Not only do these terminals provide a source of electrical energy but they also provide an excellent thermal pathway to the inside of the battery. The present invention provides for improved thermal management of electric energy sources by utilizing the terminals of the source to remove and add thermal energy.

The invention is defined by the features of the independent claims. Some specific embodiments are defined in the dependent claims.

According to a first aspect of the present invention, there is provided an electric power source equipped with a thermal control system comprising: an electric power source having at least two terminals for supplying electric current; and at least one heat exchanger affixed to a surface of at least one of at least one of the two terminals.

According to a second aspect of the present invention, there is provided a combination electric motor drive and thermal control system for an electrical energy source comprising: an electric motor drive configured to adapt energy sourced from an attached electrical energy source for use by an attached electric motor; and a thermal control system comprising at least one heat exchanger configured to be in thermal contact with at least one terminal of the attached electrical energy source.

According to a third aspect of the present invention, there is provided a multi-cell battery pack having an integrated thermal management system comprising: a plurality of battery cells, a negative conductor connecting the negative poles of the batteries, a positive conductor connecting the positive poles of the batteries, and a heat exchanging element affixed and thermally connected to at least one of the negative conductor and positive conductor.

### BRIEF DESCRIPTION OF THE DRAWINGS

FIG. 1 illustrates a lithium battery particularly suited for use with the present invention.

FIGS. 2A and 2B illustrate an electrical energy source equipped with a thermal management system according to at least some embodiments of the present invention.

FIG. 3 illustrates another electrical energy source equipped with a thermal management system according to certain embodiments of the present invention.

FIGS. 4A and 4B illustrate the operation of a thermal management system according to an embodiment of the present invention.

FIG. 5 a thermal management system according to at least some embodiments of the present invention which utilizes a controller.

FIG. 6 shows a battery pack according to an embodiment of the present invention.

FIG. 7 shows a controller according to an embodiment of the present invention.

### EMBODIMENTS

Definitions

In this context, temperature management refers to the heating, cooling and temperature maintenance.

As discussed herein a battery or other energy source is used as a description for an electrical energy source. It should be understood that many items can be employed as an electrical energy source.

As discussed herein an electric drive is a component which regulates or transforms the electric energy in order to control or supply a motor or other attached load.

As discussed herein a heat exchanging element is a component which is designed to efficiently transfer thermal energy. Examples of such elements include but are not limited to: radiators, heat sinks and other types of heat exchangers.

According to the present invention, the heat transfer capacities of the terminals of a battery are employed in order to provide more efficient management of the internal battery temperature. A temperature management system according to the present invention may be coupled with a drive adapted for use with the attached battery.

Generally electric vehicles employ batteries consisting of tens or hundreds of cells connected in a variety of parallel and series orientations to form a battery pack. However, as discussed in Finnish Patent Application 20175422, it is possible to employ single cell batteries to power electric vehicles. In a similar vein it is possible to employ greatly simplified battery packs. Such battery packs generally have relatively large terminals in order to allow for the higher current loads associated with single cell and simplified battery packs.

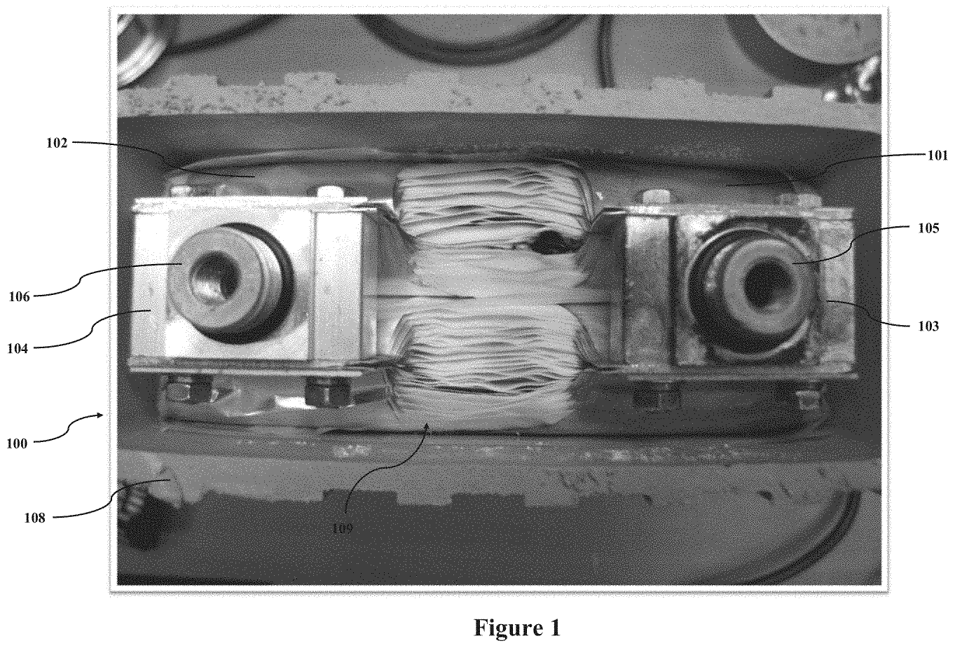

FIG. 1 illustrates a lithium battery 100 particularly suited for use with the present invention. In order to best show the inner workings of the battery a portion of the case 108 has been removed. As can be seen the battery 100 is comprised of a stacked set of foils 109. In this battery, stack is formed by alternating cathode foils 102 formed of, for example, an active material such as LiFePO₄ or aluminum, and anode foils 101 formed of for example, graphite or copper. These foils are separated by a microporous separator also illustrated within the figure, said separator being permeable to Li-ions. When in operation the battery 100 is sealed and an electrolyte, such as an organic solvent with lithium salt solution fills the space between the anode and cathode 108 so that lithium ions may move from the anode to the cathode when the battery is discharging and in the opposite direction when the battery is charging. The anode and cathode, or current collector foils 101 and 102 are grouped and connected to their respective terminals 103 and 104. Each of the terminals 103, 104 is also equipped with a connection, in this case threaded, 105 and 106 in order to provide a connection outside of the battery case.

As can be seen in FIG. 1, the relative cross sectional area of the foils is very large in comparison to the overall size of the battery. This is done in order to ensure that there is a good electrical connection to the polarized lithium mass and electrolyte cell inside of the battery. At the same time, the size of the foils distributes heat evenly through the cell. As shown in the following paragraphs this heat distributing effect allows for a novel and inventive approach to thermal management of at least some electric power sources. Such thermal management systems employ items such as the foils shown in FIG. 1 to more evenly supply or remove thermal energy than systems which merely regulate temperature through the casing of batteries. This even supply and dissipation of thermal energy ensure that there is a consistent and even internal temperature within electric power sources employing the present invention and as such the longevity and reliability of the sources are increased.

Within at least some rechargeable battery configurations there is a cylindrical casing formed of a conductor which acts as the negative pole of the battery, either for one large cell or as a common negative pole for a plurality of cells within the casing. Once again, this common pole allows for excellent thermal access to the cell or cells of the battery.

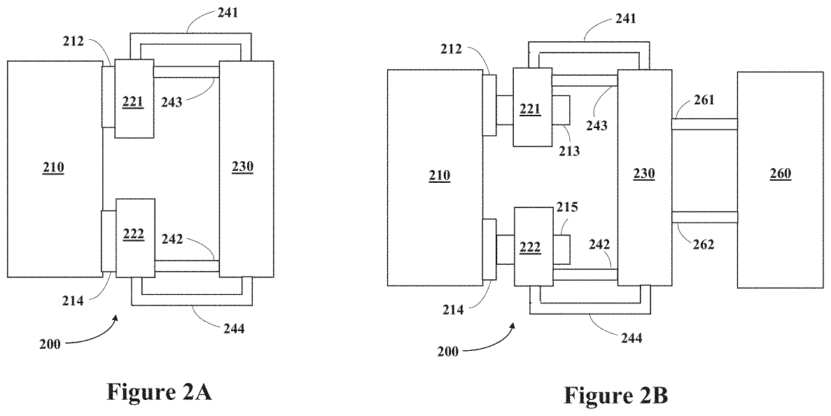

FIG. 2A illustrates an electric power source equipped with a thermal control system 200 comprising, an electric power source 210 having at least two terminals 212 and 214 for supplying electric current. The system 200 further comprises heat exchangers 221 and 222 affixed to a metal surface of the at least two terminals 212 and 214. Within certain embodiments there is only one heat exchanger employed either across both terminals or affixed to only one terminal.

As can also be seen in FIG. 2A at least some electrical power sources according to the present invention have an additional heat exchanger 230 thermally coupled to the at least one heat exchanger 221 or 222. In the embodiment illustrated within FIG. 2A the additional heat exchanger 230 or radiator is coupled to the heat exchangers 221 and 222 via fluid conduits 241-244. Certain embodiments are configured to ensure that the radiator is placed in ambient conditions so as to exhaust heat from the electrical energy source. At least some embodiments employ a cooling liquid which is not electrically conductive. Certain embodiments employ a heat pump in connection with or in lieu of the additional heat exchanger 230.

In at least some embodiments of the present invention the electrical energy source is a battery. Certain embodiments employ a single cell battery. Still other embodiments employ a single battery cell. Others, a multi-cell battery pack arranged in parallel.

FIG. 2B illustrates an electrical energy source 210 equipped with a thermal control system 200 according to the present invention wherein the heat exchangers 221 and 222 are affixed to conductors 213 and 215. The conductors 213, 215 are themselves in electrical connection with the terminals 212 and 214 of the electrical energy source 210. Once again the heat exchangers 221, 222 are connected to the radiator 230 using fluid conduits 241-244. Certain embodiments employ fluid conduits which are not electrically conductive.

Also illustrated within FIG. 2B is an external heating element 260 present in at least some embodiments of the present invention. As shown the external heating element 260 is connected to the radiator 230 via conduits 261, 262 in order to provide thermal energy to the radiator which can then be passed to the terminals 212, 214 of the battery via the heat exchangers 221, 222. The external heating element may be, for example, an electric heating element. Via this element the energy source 210 temperature can be controlled with a greater degree of accuracy.

In certain embodiments of the present invention there is a layer of electrically insulating material between the heat exchanger and the terminals or conductors. Wherein at least some embodiments utilize the heat exchanger itself as an electric conductor.

Within some embodiments of the present invention the heat exchangers are constructed from a material which is not electrically conductive, such as a plastic or composite material.

Within certain embodiments the heat exchangers comprise a heat exchanging element surrounding an electrically conducting element. For example the heat exchanger may be configured such that a conductive element is provided to connect to terminals of an electrical power source. This conductive element is then surrounded by a heat exchanging element such that installation of the heat exchanger on the electrical power source is much easier. A user would simply need to attach the combined heat exchanger and electrical conductor between the electrical power source and whatever they wished to power.

At least some electrical power sources according to the present invention further comprise a heating element configured to provide thermal energy to the heat exchangers. Certain power sources further comprise a pump for moving cooling fluid through the heat exchangers.

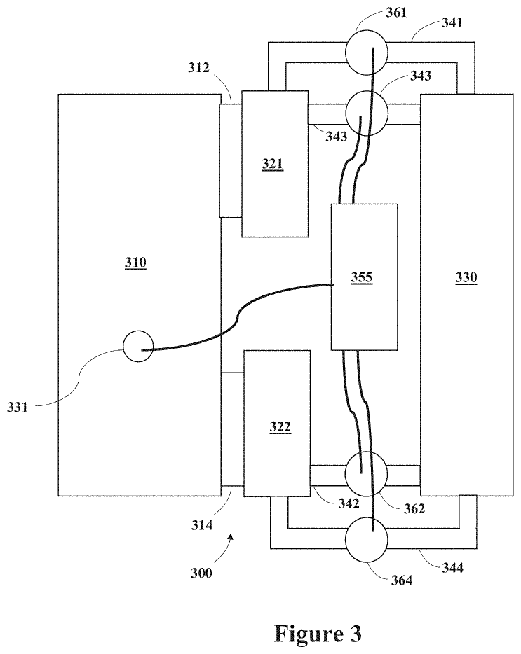

FIG. 3 illustrates an electric power system 300 according to the present invention further comprising a thermal control unit 355 for controlling the temperature of the electric power source. Once again having an electrical power source 310 having two terminals 312 and 314 for providing electrical current. Heat exchangers 321 and 322 are providing on the terminals 312, 314. The heat exchangers 321 and 322 are in thermal connection with a radiator 330 via fluid conduits 341-344. A thermal control unit 355 is connected to valves 361-364 in order to control a temperature of the electrical energy source 310. Within certain embodiments the valves 361-364 are replaced by or augmented by pumps.

Also depicted within FIG. 3 is a temperature sensor 331 affixed to the electric power source 310. The temperature sensor 331 provides the present temperature of the power source 310 and allows the control unit to adjust the valves and or pumps in order to maintain an optimal power source temperature.

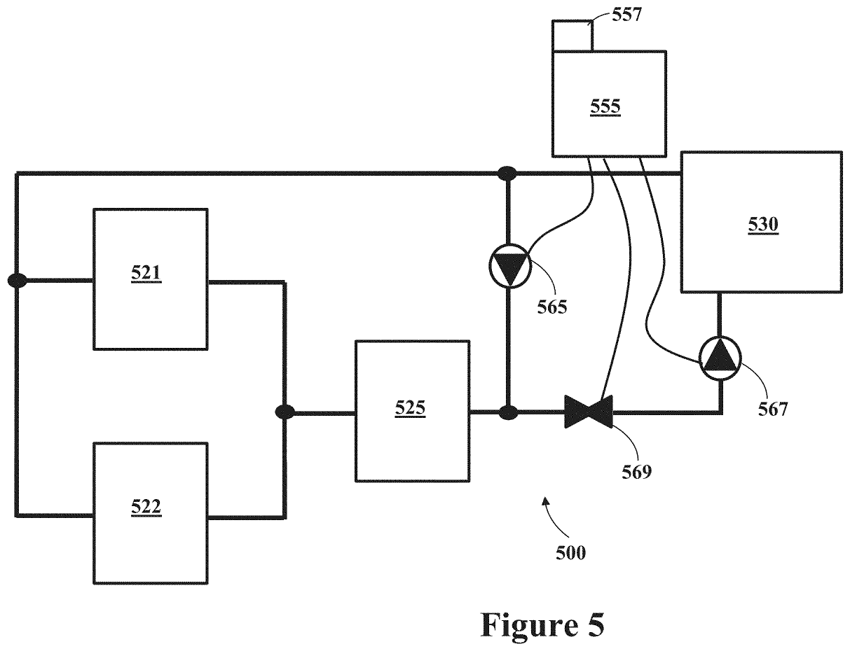

FIG. 5 shows a thermal management system 500 according to the present invention utilizing a controller 555. For simplicity, only the heat exchangers 521, 522 configured to be placed on terminals of the energy source, the heat exchanger 525 configured to be placed on the electric drive and radiator or additional heat exchanger 530 are shown. As can be seen the controller 555 is linked to two pumps 565, 567 and a valve 569 so as to be able to operate the pumps and valve. The controller 555 also has an input 557 for receiving a temperature of the connected electric energy source. Based on this temperature of the electric energy source the controller operates the valve and pumps in order to try and maintain an optimal temperature or temperature range of the electric energy source.

Within certain embodiments of the present invention employing a controller, pumps and valves as illustrated in FIG. 5, the controller 555 determines if the temperature of the battery is greater than a predetermine threshold temperature. If the temperature exceeds this threshold pump 567 is activated and valve 569 is opened. Pump 567 then causes a cooling fluid to flow though the radiator 530 where it may dissipate thermal energy and then through the terminal heat exchangers 521, 522 and then the heat exchanger of the electric drive 525 where the cooling fluid absorbs thermal energy which in turn is dissipated when the cooling fluid is pumped back though the radiator 530. In this fashion thermal energy is dissipated from both the electric energy source and the electric drive.

Within at least some embodiments of the present invention employing a controller, pumps and valves as illustrated in FIG. 5, if the temperature does not exceed the predetermined threshold pump 565 is activated and valve 569 is closed. When pump 565 is activated the cooling fluid is directed to flow first through the heat exchanger of the electric drive 525 where it absorbs thermal energy and then through the terminal heat exchangers 521, 522 where it deposits this thermal energy. In this fashion the terminals of the electric energy source and thus the energy source itself is warmed.

It at least some systems according to the present invention the thermal controller is an integral part of the electric drive.

Certain embodiments of the present invention contain a control system which monitors the temperature of the battery along with the temperature of the electric drive or connected power electronics. The control system then adjusts the thermal management system to optimize thermal flow between the components.

Within certain embodiments of the present invention involving a controller unit for the thermal control system the control unit comprises at least one memory and at least one processor. The controller unit is configured to store temperature sensor data indicative of the battery temperature along with corresponding vehicle performance data such as, for example, a vehicle speed or torque. This data can then be used for proactive control of the temperature management system. For example, within at least some embodiments of the present invention, if the battery is near the ideal operating temperature, the thermal management system may begin cooling operations when the vehicle's speed exceeds a certain threshold, even before the battery temperature has risen outside of the ideal range. For example, if the vehicle exceeds 80 km/h and the battery temperature is still below an upper temperature limit, the thermal system would already begin dissipating heat to ensure that the battery temperature does not exceed the upper temperature limit due to the increased load. Thus the thermal management system is able to compensate for the sudden increase in heat due to an increased draw of energy from the battery.

At least some embodiments of the present invention provide for a thermal management system which is configured to keep the battery at an ideal temperature for the present performance of the electric drive. For example, when employed within an electric vehicle in normal driving conditions, the thermal management system will ensure that the battery and electronics are at a temperature which minimizes resistive loses. Certain embodiments provide for supplying heat from electrical components, for example an electric drive, to cold battery in order to quickly raise the temperature of the battery and ensure efficient operation.

In at least some embodiments of the present invention the electric drive is programmed to operate at less than peak efficiency for a period of time in order to generate heat to warm the electric energy source. This may actually lead to greater efficiency overall as heating the energy source increases the efficiency of the source.

Within combined electric drive and thermal management systems according to the present invention the internal resistance of the battery and electrical components can be used to quickly raise the temperature of the battery. The fact that warm electronics experience higher internal resistance can also be used to more quickly increase the temperature of the battery by allowing the electronics to warm and thus provide their waste heat to the battery as described in the system below.

Within at least some embodiments the electric components or electric drive is allowed to operate at a higher than standard operating temperature in order to more quickly heat the battery, once the battery is at a desired operating temperature the electronics are cooled. In this matter total losses of the combined thermal and electric drive system can be minimized.

Heat exchangers according to the present invention which are configured to be affixed to primary conductors or terminals of a battery have the potential to be conductively connected to the battery. As such it is important to ensure that the heat exchangers are electrically isolated in some fashion. In certain embodiments this is accomplished through thermally conductive but electrically insulating material which is placed between the heat exchangers and the conductors or terminals. For example, KERATHERM® Softtherm® films are a group of high elastic ceramic filled foils. They are characterized by their extremely good compressibility, their optimum with good thermal conductivity and good electrical properties at the same time. In some embodiments the heat exchangers are energized and the thermal exchange means, for example tubes for cooling fluid, provide insulation, for example by constructing the tubes from a non-electrically conductive material.

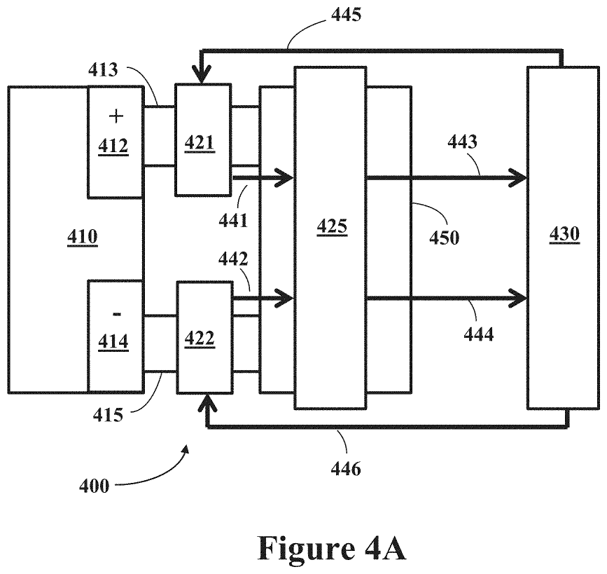

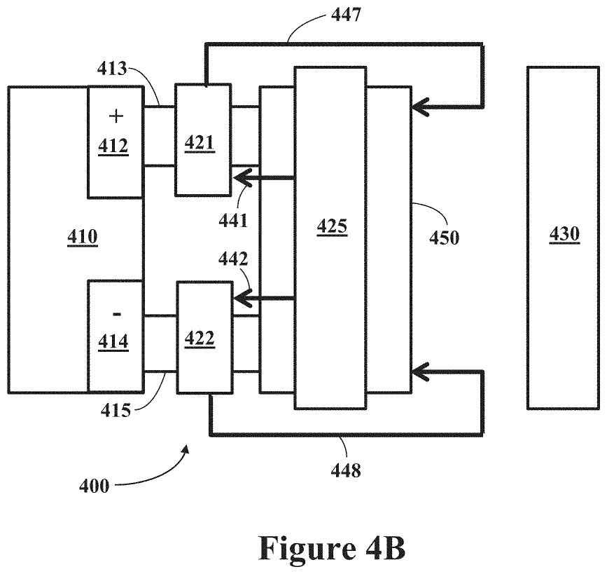

FIGS. 4A and 4B illustrate the operation of a combination electrical drive and thermal management system 400 according to an embodiment of the present invention. As illustrated an electric drive 450, for example a DC to DC converter module as discussed in Finnish Patent Application 20175422, is conductively connected to a battery 410 using primary conductors 413 and 415 connected to contact terminals 412 and 414 of the battery. The electric drive 450 is also thermally connected to the battery 410 via the primary conductors 413, 415 and contact terminals 412, 414. As can be seen the contact terminals 412, 414 and primary conductors 413, 415 are relatively large. Heat exchangers 421, 422, 425 are supplied on both the electric drive 450 itself and the primary conductors 413, 415. A radiator 430 is also illustrated in thermal connection with the heat exchangers 421, 422, 425.

Heat flow in FIGS. 4A and 4B is illustrated via arrows 441-448 representing a cooling fluid flow. This cooling fluid flow is facilitated through pipes connecting the heat exchangers 421, 422, 425 and radiator 430. In certain embodiments valves and/or pumps are employed to further control the flow of cooling fluid.

FIG. 4A illustrates the system 400 in a cooling mode wherein the internal battery temperature is lowered. In this mode cooling fluid removes heat from both the battery via heat exchangers 421 and 422 attached to primary conductors 413 and 415 and from the electric drive 450 via heat exchanger 425. This heated cooling fluid is then moved to the radiator 430 where heat is dissipated and thus the cooling fluid is cooled. This cooled cooling fluid is then returned to the heat exchangers 421 and 422 to facilitate further heat transfer.

FIG. 4B illustrates the system 400 in a heating mode wherein the internal battery is raised. In this mode cooling fluid is first warmed using waste heat from the electric drive 450 and then transfer to the heat exchangers 421, 422 attached to the primary conductors 413, 415. Within the heat exchangers 421, 422, heat is transferred from the cooling fluid to the primary conductors 413, 415 and then the cooling fluid is returned to the heat exchanger 425 attached to the electric drive 450 in order to be reheated. In this manner waste heat from the electric drive is used to raise the internal temperature of the battery.

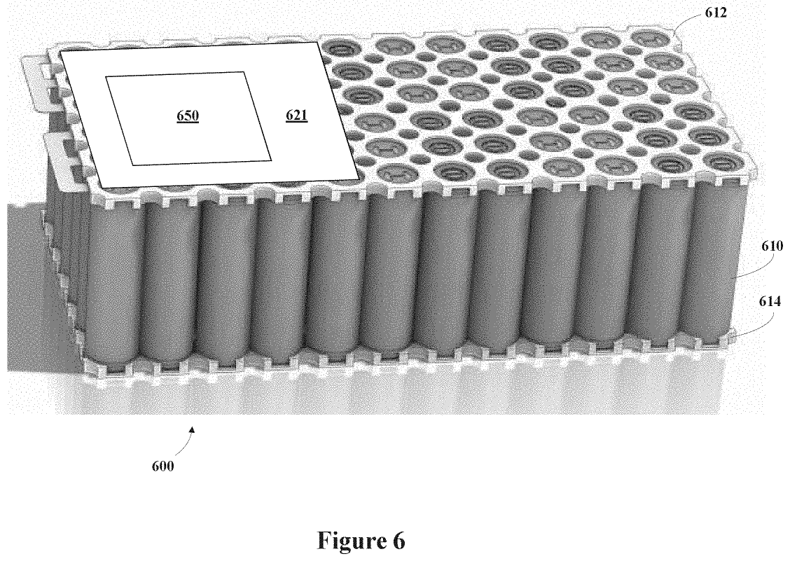

FIG. 6 illustrates one embodiment of the present invention as employed with a multi-cell battery pack 600. Within the battery pack 600 illustrated there are a plurality of individual batteries 610 with one conductive element 612 connecting the batteries 610 negative terminals and one conductive element 614 connecting the batteries 610 positive terminals. A heat exchanger 621 is provided on the conductive element 612 for the negative terminals which is then used to manage the temperature of the battery pack. As also illustrated within FIG. 6, an electronic drive 650 or other hardware may also be thermally connected to the heat exchanger 621. This allows for both heating of the battery pack using waste heat from the electronic drive 650. The placement of the electronic drive 650 on the heat exchanger 621 also allows for cooling of both electronic drive 650 and battery pack 600 by a single heat exchanger.

Within at least some embodiments of the present invention the negative terminal is employed for thermal management as a large variety of energy sources have better thermal access via the negative terminal for a variety of reasons. As discussed above, often the negative terminal for batteries is connected with the casing and thus in contact with more of the battery. This holds true for single cell batteries and battery packs wherein the individual cells having casings which are connected to the negative terminal. Further, within at least some sources, the negative terminal is copper and thus has a better thermal conductivity than an aluminum positive terminal.

While the other elements of the thermal management system such as cooling fluid pipes, radiators and a controller are not shown within FIG. 6, it should be understood that any of the systems for managing thermal energy discussed herein may be employed also with this multi-cell battery pack embodiments.

At least some embodiments of the present invention employing a multi-cell battery pack are constructed such that the case of the battery pack is in thermal contact with the negative terminals of the cells within the pack. For example the case may act as a common negative terminal for all of the individual batteries contained within the battery pack.

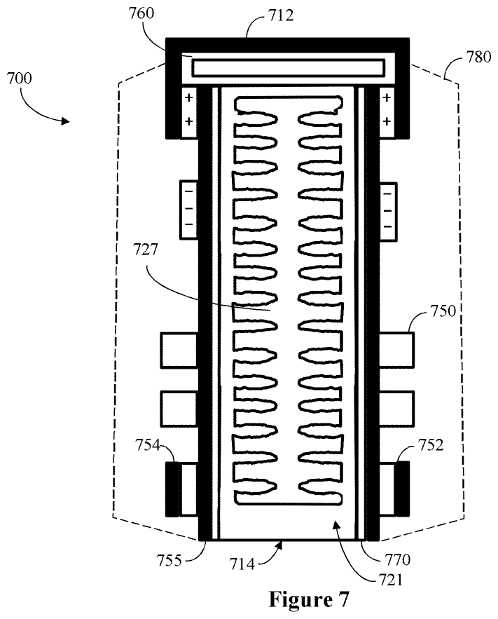

FIG. 7 illustrates a power electronics and cooling package 700 according to yet another embodiment of the present invention. As shown, power electronics 750 are affixed to a cooling element 721 designed to be affixed to an electric energy source such as a battery. As seen the cooling element 721 is surrounded by an insulating material 770 save for one side which is designed to act as the negative terminal 714. Opposite the negative terminal the positive terminal 712. These positive and negative terminals are designed to be conductively connected to an energy source such that electricity is provided to the power electronics and a good thermal connection is made with at least one terminal of the energy source. Thus, when thermal energy is supplied or removed from the heat exchanger, the thermal condition of both the energy source and power electronics may be maintained.

As seen contained within the optional housing 780 power electronics 750 comprising an electric drive are disposed on the heat exchanger via a circuit board 755. This circuit board provides connections to both the positive 712 and negative 714 terminals of the package 700. The package takes in electric energy from the terminals 712 and 714 and converts it via the power electronics 750 before outputting the electricity at the output terminals 752 and 754. This conversion could be, for example, raising the output voltage of a connected battery pack. The power electronics may also be employed to drive an electric motor.

As seen atop FIG. 7, certain power electronics and cooling packages according to the present invention provide for a space 760 for control wires so that signals may be transferred between sides of the heat exchangers.

The heat exchanger 721 illustrated within FIG. 7 is designed to work through convection by moving air through the center cavity 727. This eliminates the need for providing cooling liquid to the heat exchanger and then to a radiator. As the package 700 of FIG. 7 is self-contained, it may be retrofitted on existing electric vehicles in order to provide both thermal management of the battery or other electric energy source and conversion or drive as necessary.

In certain embodiments the heat exchangers are supplied directly on the contact terminals of the battery. In some embodiments the entire electric drive and thermal management system is incorporated so as to provide a single connected to the battery.

At least some embodiments of the present invention employ a heating element which can be used to supply thermal energy directly to the battery. In some embodiments the heating element warms cooling fluid which is supplied to the heat exchangers disposed on the terminals or primary conductors and thus raises the internal temperature of the battery. In certain embodiments the heating element is an external heater that receives outside energy such as an electrical connection that may also be used to charge a connected battery. In other embodiments the heating element may burn a fuel to provide heat.

At least some thermal management systems according to the present invention provide for heating of the battery when in a “parking mode”. For example when an electric vehicle is parked and connected to an outside energy source such as a charging outlined. In such situations the thermal management system using energy from this outside source to direct thermal energy to the battery. As discussed above this may be accomplished, for example, through the use of a heating element wherein an electrical heating element supplies thermal energy to the heat exchangers disposed on the battery terminals or primary conductors and thus warms the battery.

Certain embodiments of the present invention provide for a multi-cell battery pack having an integrated thermal management system. This system includes a plurality of battery cells, a negative conductor connecting the negative poles of the batteries, a positive conductor connecting the positive poles of the batteries, and a heat exchanging element affixed and thermally connected to at least one of the negative conductor and positive conductor. Within some embodiments the heat exchanging element acts as at least one of the negative conductor and positive conductor.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

1. An electric power source equipped with a thermal control system comprising:
an electric power source having at least two terminals for supplying electric current; and
at least one heat exchanger affixed to a surface of at least one of the two terminals, wherein:
the heat exchanger comprises an integral electric conductor, and
the heat exchanger is configured to be placed between the at least one of the two terminals and an electric load connected to the electric power source.

2. The electric power source of claim 1 wherein the heat exchanger comprises channels for a cooling fluid.

3. The electric power source of claim 1 wherein the electric power source is a battery, such as a single cell battery or a multi-cell battery pack.

4. The electric power source of claim 1 wherein there are two heat exchangers, one for each of the terminals of the power source.

5. The electric power source of claim 1 further comprising an additional heat exchanger thermally coupled to the at least one heat exchanger.

6. The electric power source of claim 1 wherein the heat exchangers comprise a heat exchanging element surrounding an electrically conducting element.

7. The electric power source of claim 1 further comprising lines for carrying a cooling fluid.

8. The electric power source of claim 7 wherein the lines contain a cooling fluid, preferable a cooling fluid which is not electrically conductive

9. The electric power source of claim 7 wherein the lines for the cooling fluid are not electrically conductive.

10. The electrical power source of claim 1 further comprising a heating element configured to provide thermal energy to the heat exchangers.

11. The electrical power source of claim 1 further comprising a pump for moving cooling fluid through the heat exchangers.

12. A combination electric motor drive and thermal control system for an electrical energy source comprising:
an electric motor drive configured to adapt energy sourced from an attached electrical energy source for use by an attached electric motor; and
a thermal control system comprising at least one heat exchanger configured to be in thermal contact with at least one terminal of the attached electrical energy source, wherein:
the heat exchanger comprises an integral electric conductor, and
the heat exchanger is further configured to be conductively placed between the at least one terminal of the attached electrical energy source and the electric motor drive.

13. The combination system of claim 12 wherein the thermal control system further comprises a temperature sensor.

14. The combination system of claim 12 further comprising a heat exchanger affixed to the electric motor drive which is in thermal connection with the heat exchanger configured to be in thermal contact with terminals of the attached electrical energy source.

15. The combination system of claim 12 further comprising an electrical energy source in electrical and thermal connection with the at least one heat exchanger configured to be in thermal contact with terminals of the attached electrical energy source.

16. The combination system of claim 12 wherein the electrical energy source is a single cell battery or a plurality of parallel battery cells.

17. The combination system of claim 12 further comprising a thermal controller for controlling a flow of cooling fluid between the elements of the system.

18. The combination system of claim 17 wherein the thermal controller is configured to maintain the temperature of the attached energy source between an upper and lower temperature limit, preferably based at least partially on an input indicative of the temperature of the attached energy source.

19. The combination system of claim 12 wherein the system is configured to use heat from the electric drive to heat the attached energy source.

20. A multi-cell battery pack having an integrated thermal management system comprising:
a plurality of battery cells,
a negative conductor connecting the negative poles of the batteries,
a positive conductor connecting the positive poles of the batteries, and
a heat exchanging element affixed and thermally connected to at least one of the negative conductor and positive conductor, wherein:
the heat exchanging element comprises an integral electric conductor, and
the heat exchanger is configured to be conductively placed between either the positive conductor or negative conductor and a load connected to the battery pack.
